(19) United States
(12) Patent Application Publication
(10) Pub. No.: US 2004/0201577 A1
(43) Pub. Date: Oct. 14, 2004

(54) Input element and a method for making an input to a touch-pad

(75) Inventor: Shoji Yamada, Tokyo (JP)

Correspondence Address: GREENBLUM & BERNSTEIN, P.L.C., 1950 ROLAND CLARKE PLACE, RESTON, VA, 20191, US

(73) Assignee: Quasar System Inc., Kanagawa (JP)

(21) Appl. No.: 10/731,477

(22) Filed: Dec. 10, 2003

(30) Foreign Application Priority Data
Apr. 8, 2003 (JP) 2003-103673

(51) Int. Cl. G09G 5/00

(52) U.S. Cl. 345/173

(57) ABSTRACT

An input element is used to make inputs to a computer having a touch-pad responsive to changes of static capacity. The input element has a conductive pad contact part which contacts in face-to-face manner to the touch-pad. The pad contact part is pivotally connected to a grip part so that the contact face always makes the contact face contacted to a surface of the touch-pad. Also provided is an input method using the aforementioned input element.

### TECHNICAL FIELD

The present invention relates to control of an information processing apparatus using a touch-pad, and more particularly, the present invention relates to an input element for controlling easier the information processing apparatus through the touch-pad and a method for making an input thereto using the input element.

### BACKGROUND ART

In recent years, an information processing apparatus, more particularly, portable information processing apparatuses including computers such as a personal computer and a PDA used popularly and then various methods for driving the portable information processing apparatuses have been proposed. The input methods described above include the method in which a position of a pointer displayed on a display screen of the information processing apparatus is controlled using a mouse or the method in which a position of a pointer is controlled using static capacitance such as a touch-pad disposed to a part of an information processing apparatus.

In portable information processing apparatuses particularly such as a notebook type personal computer, in order to improve portability, the following input method is often used:

(i) providing position control of the pointer using the touch-pad;

(ii) followed by pressing a button or buttons disposed adjacent to the touch-pad so as to select applications or files.

FIG. 5 shows a general perspective view of a conventional notebook type personal computer. The notebook type personal computer 100 (hereunder simply referred to a computer) comprises a case 104, a display part 102 such as a liquid crystal display or a plasma display or a CRT. The case 104 comprises a keyboard 104a so that a user is allowed to make input thereto. As shown in FIG. 5, in front of the keyboard 104a of the case 104, a touch-pad 108 is disposed and buttons 108a, 108b are placed adjacent to the touch-pad 108. A user of the computer 100 makes inputs through the keyboard by his or her hands and fingers. The user also may select his or her desired files or applications by moving a pointing icon 110 (hereunder simply referred to pointer), for example, along with a direction of an arrow D while contacting his or her finger onto the touch-pad 108.

In the conventional input method using a touch-pad, however, has the drawback in which fingers sometime contact to plural points of the touch-pad because the touch-pad may be operated by fingers or palm and the touch-pad is disposed adjacent to the keyboard. In addition, contact conditions of the fingers can not be always constant so that several drawbacks such as unexpected movements of the pointer or low input accuracy are known.

Because of the drawbacks described above, it is known that many users often use an auxiliary pointing device other than the touch-pad 108 such as a mouse 112 together with the touch-pad 108. The mouse 112 usually retains a track ball therein and can detect rotation amounts and directions of the track ball by rollers and moves positions of the pointer on the display part depending on the rotation amounts and directions so that the mouse provides sufficient accuracies and efficiencies. On the other hand, the mouse 112 is provided separately with the computer 104, and then adverse effects spoil the portability of the computer 104. Hence, the mouse 112 may not be available at any time. Therefore, the input through the touch-pad 108 has been auxiliary used when the user can not use the mouse 112 such as under out-of-office situations, or under mobile situations.

In order to improve the above drawbacks, several methods have been proposed. For example, Japanese Patent (Laid-Open) No. 9-319508 specification discloses a touch-pad input method in which inputs to a touch-pad by fingers or stationary are allowed. The touch-pad input disclosed in Japanese Patent (Laid-Open) No. 9-319508 allows inputs mainly through resistance changes due to pressures onto the touch-pad and any particular input element enabling inputs to a touch-pad based on static capacitance is not disclosed, even though usage of a touch-pad with static capacitance is suggested therein.

In turn, Japanese Patent (Laid-Open) No. 10-3349 specification, a touch-pad with improved input capability is disclosed. The input capability is improved so as to be responsible to the case in which inputs are made at plural positions on the touch-pad; however, any input element providing sufficient input capability to the touch-pad based on a static capacity is not disclosed.

Furthermore, Japanese Patent (Laid-Open) No. 2000-148347 discloses a facility extension switch disposed to the touch-pad to which inputs are made by a pen; however, the construction for the input pen is not disclosed and is not discussed in detail. Further addition, Japanese Patent (Laid-Open) No. 2001-282450 specification also discloses a pointing device for enabling input using a finger, a stick, or a special pen.

However, the previous arts fails to disclose an input element and input method using the input element suitably applied to a touch-pad based on the static capacitance.

[Problem to be Solved by Invention]

Accordingly, though the above various conventional arts are present, disadvantages, that availability of the touch-pad input method is limited and availability of the portable information processing apparatus is spoiled, are still remained. Because of the above disadvantages, the improvement of input capability of the touch-pad has been required.

[Means to Solve Problem]

The present invention has been made with respect to the above disadvantages of inputs to the information processing apparatuses by the above conventional touch-pad. The inventor considers that a touch-pad receives inputs in response to changes of static capacitance, and the present invention has been made in the recognition that the above disadvantages may be overcome if an input element is provided, which makes it possible to change the static capacitance in similar degrees with a finger to be detected. The touch-pad herein may include the touch-pad which adopts the method for controlling the pointer in response to the change of the static capacitance as well as the touch-pad which adopts the method for controlling the pointer in response to the change of the static capacitance and pressures by a finger or an input element.

Accordingly, the present invention has been made by the fact that the touch-pad may accept the user input by a touch-pad contact part having a contact face being capable of a face-to-face contact with the touch-pad rather than a user's finger. According to the present invention, it is possible to provide stable inputs to information processing apparatuses with an always stable contact area and conditions through the touch-pad, thereby largely improving input accuracy and handling performance.

The touch-pad contact part used in the present invention at least includes the contact face to be two-dimensionally contacted to a surface of the touch-pad. The contact surface of the above touch-pad contact part can provide the change of the static capacitance in the amount being sufficiently detected by the touch-pad. In addition, the contact surface is constructed to be a flat face such that the touch-pad contact part may slide smoothly along with the touch-pad.

As described above, in accordance with the present invention, an input element used for a touch-pad disposed to an information processing apparatus and is responsible to changes of a static capacity, may be provided. The input element comprises a conductive pad contact part which contacts onto said touch-pad in a face-to-face manner. The input element further comprises a conductive grip part and the grip part and the pad contact part is connected via a pivot connection therebetween.

Further according to the present invention, the input element has a paper weight shape or a pencil shape and the input element makes an input to said information processing apparatus through the change of the static capacity interfaced by said touch-pad.

Further according to the present invention, a method for making an input to an information processing apparatus via a touch-pad may be provided. The touch pad of said information processing apparatus is responsible to a change of a static capacity and the method comprises the steps of:

providing an input element comprising a conductive pad contact part which makes a face-to face contact onto said touch-pad; and

making said input element contact to a touch-pad surface in a face-to-face manner such that said static capacity is changed.

[Embodiment for Practicing Invention]

Now, the present invention will be explained using particular embodiments depicted in drawings; however, the present invention is not limited to the embodiments described below. FIG. 1 is a perspective view which depicts an information processing apparatus in the present invention assuming the information processing apparatus to be the computer 10. The information processing apparatus of the present invention may not be limited to the notebook type computer 10 as depicted in FIG. 1 as far as the information processing apparatus is of a portable type such as PDA. With referring to FIG. 1, the computer 10 comprises a display part 12 such as a liquid crystal display or a plasma display and a case 14 on which the display part 12 is supported. To the case 14, further the keyboard 16, the touch-pad 18, and buttons 20a, 20b which support inputs through the touch-pad 18 are disposed.

The touch-pad of the computer 10 depicted in FIG. 1 may adopt the construction such as, for example, disclosed in Japanese Patent (Laid-Open) No. 10-3349 etc. so that positions of the pointer 22 displayed on the display part 12 may be controlled upon sensing the static capacitance. Here, a construction of touch-pad is generally detailed. The touch-pad 18 comprises a planer panel consisting of the surface of the touch-pad 18, and layered electrodes, which are disposed under the panel extending two-dimensionally right to left. When the user touches to the planer panel of the touch-pad 18, the planer electrodes detect the change of the static capacitance of the region on the touch-pad corresponding to the finger.

From the position of the touch-pad on which the change of the static capacitance is detected, the computer 10 obtains a first position as an original position and stores the first position in an appropriate memory. Thereafter, the computer 10 obtains a second position corresponding to the static capacitance where a finger or the input element of the present invention is moved while contacting to the planer panel, and stores the second position in the memory means. Then the computer 10 read out the first and second positions from the memory to compute a movement vector along with the touch-pad 18.

The pointer 22 on the display part 12 may be moved by extending a norm of the movement vector in a predetermined extension ratio so as to provide an amount of movement according to a previously determined touch-panel size and a displayable area of the display part 12, and then making the computer compute another new position coordinate on the display part 12 using a direction of the movement vector and a position coordinate of the pointer 22 on the display part 12.

The user traces the touch-pad 18 with his or her finger while viewing movements of the pointer 22 on the display part 12 and drags the pointer 22 along with the arrow A to the position of icon 24 indicating files or applications. The user thereafter clicks the buttons 20a or 20b for supporting inputs and can make desired files or applications executed. The touch-pad 18 available in the present invention adopts generally the above construction, but not limited thereto, the present invention may use any embodiment of touch-pad and any method for computing the amounts of movement as far as the position is obtained by the static capacity.

The present invention cause the change of the static capacity to the touch-pad 18 described in FIG. 1 using the input element so as to cause the change of the static capacitance. FIG. 2 shows a practical embodiment of the input element of the present invention. Now, the construction of the input element is detailed. The input element 26 depicted in FIG. 2 almost has a pencil shape, and FIG. 2(a) shows a front view and FIG. 2(b) shows a side view. The input element 26 shown in FIG. 2 further comprises a grip part 28 and a pad contact part 30 being pivotally connected to the grip part 28.

The pad contact part 30 comprises a ball-shaped part 30a and a contact face 30b. The ball-shaped part 30a pivotally connects the contact face 30b to the grip part 28 such that a contact area of the contact face 30b against to the surface of the touch-pad 18 is unchanged. In addition, a resilient member such as a spring may be disposed between the contact face 30b and the grip part 28 in the present invention so as to improve the face-to-face contact performance.

The grip part 28 of the touch-panel input element 26 according to the present invention may be a pipe shape made of conductive material. In the present invention, the input element may be any shape such as a handle or a stick made of conductive material rather than the pipe shape, or alternatively, the input element may be made of any dielectric material coated with a conductive coating.

The pad contact part 30 may be structured to be a conductive member selected from brass, iron, stainless steel, or plastics with a conductive coating. The contact face 30b is preferably shaped to a flat face such that the contact face 30b may be moved smoothly. A cross section of the contact face 30b may be any shape; however, the cross section may preferably be a circle when considering handling thereof or damages such as scratches to the touch-pad 18.

Particularly, in the specific embodiment of the present invention, it was found that the circular contact face 30b with its diameter at least about 3-5 mm showed a good input performance. There is no substantial limitation to the diameter of the contact face 30a, however, the diameter becomes smaller and smaller, a moving range of the pointer 20 becomes larger and larger. In the present invention, the contact face 30b may be adapted to have its area corresponding to the diameter smaller than or larger than the diameter described above depending on sensitivity and the size of the specific touch-pad used.

In the specific embodiment of the present invention shown in FIG. 2, a clip part 32 which is depicted in detail in FIG. 2(b) is formed at a top portion 28a of the grip part 28 of the input element 26. In addition, the grip part 28 is formed from a hollow member made of aluminum so as to improve its weight and portability.

FIG. 3 depicts an enlarged partial cross sectional view of the connection shown by broken lines in FIG. 2 between the grip part 28 and the pad contact part 30. FIG. 3(a) shows a first embodiment of the connection and FIG. 3(b) shows another embodiment of the connection. As shown in FIG. 3(a) and FIG. 3(b), the ball shaped part 30a of the pad contact part 30 is received in an inner space 34 defined by grip part 28 and the ball shaped part 30a is prevented from going into the inner space 34 defined in the grip part 28 beyond a predetermined position by an engaging member 36.

The pad contact part 30 comprises a ball shaped part 30a, the contact face 30b, and a connection part 30c connecting between the contact face 30b and the ball shaped part 30a as shown in FIG. 3. The ball shaped part 30a is supported by the grip portion 28 at the opposite side of the surface S of the touch-pad.

The inner space 34 defined by the grip part 28 is sized enough to receive the ball shaped part 30a and the center of the ball shaped part 30a is positioned at the inner space 34 side with respect to a lower end 28b of the grip part 28. On the other hand, the lower end 28b of the grip part 28 is formed to have slightly smaller diameter than the diameter of the ball shaped part 30a and contacts to the ball shaped part 30a for allowing the ball shaped part 30a to provide pivot movements.

The engaging member 36 is shaped to an engaging block and in FIG. 3(a), the engaging block is fixed, for example, by an adhesive agent. In the embodiment shown in FIG. 3(b), the engaging member 36 is shaped to have a ring or a pipe and is fixed relatively to the grip part 28 so that the ball shaped part 30a is kept at adequate position. Further according to another embodiment of the present invention, the engaging member 36 shown in FIG. 3(b) may be extended to the top end portion 28a to be integrated to the grip part 28 at the top end portion 28a.

In a further another embodiment of the present invention, the pat contact part 30 may be adequately sized such that the pad contact part 30 is handled with a hand and may be separately used as an independent input element without connecting to the grip part 28. In this case, this input element has some drawbacks with respect to the input elements shown in FIGS. 2 and 3 because of its portability and possibilities of damages to the display part 12 due to carelessness not to be removed thereof from the touch-pad; however, it was confirmed by the inventor that the input performance to the touch-pad 18 is compatible to the performances of the input elements shown in FIGS. 2 and 3.

FIG. 4 depicts an embodiment of the method for making inputs to the information processing apparatus using the input element 26 according to the present invention. A user first takes hold the grip part 28 of the input element 26 and has the contact face 30b contact to the surface of the touch-pad 18. At this time, the original position on the touch-pad 18 is obtained by the computer 10 through the touch-pad 18. Usually, the changes of the static capacitance of some amounts occur on the touch-pad 18. Then the original position may be given as an electrode position that provides the largest change in the static capacitance. Alternatively, the original position may be determined by the estimated value which is provided by estimating the center of the area where the changes in the static capacitance are detected. Further more, the original position may be obtained using any available method known in the art so far.

Thereafter, the user moves the input element 26 on the touch-pad 18 along with the arrow B from the original point while viewing the pointer 22 displayed on the display part 12. In this operation, the pad contact part 30 of the input element 26 pivots about the grip part 28 with respect to angles of user's hand, and therefore, the contact face 30b always contacts onto the surface of the touch-pad without depending on the angle of user's hand. In addition, the changes of the static capacitance provided by the contiguously moved contact surface 30b makes it possible to estimate or acquire an after-moved position as the second position because the contact face 30b provides good contact constantly in the face-to-face manner.

The size of the contact face 30b is, as described above, sized to have a size of an about user's index fingertip so that the position of the contact face 30b may have the computer 10 to obtain the original position and the after-moved position through the touch-pad. When a new position is defined by the movement of the input element 26, the computer 10 computes the movement vector on the touch-pad 18.

After the movement vector being computed, the computer 10 computes a new position for the pointer 22 displayed on the display part 12 in response to the movement vector and provides the pointer 22b on the new position shown by broken lined position such that the pointer 22 is moved along with the direction shown by the arrow C. The above movements may be repeated to the position where the pointer 22 overlaps to the application icons or the file icons as shown in FIG. 4. In this stage, a user may actuate a desired application when a user executes certain operations such as double clicks of the button 20a.

Alternative embodiment of the present invention, rather than clicking the button 20a, the application icon may be activated by contacting a separating the input element 26 for several times quickly, for example, two times. Further alternative embodiment of the present invention, the application may be automatically activated by determining that a user has overlapped the pointer 22 on a predetermined icon at least a predetermined time from a threshold time provided as software. The input element 26 according to the present invention may be used in any input method by fingers through the touch-pad 18 other than the methods described above.

The input element 26 may be detachably retained in the retainer space 40 such as the recess or the hole provided in the case 14 of the portable information processing apparatus such as a notebook type personal computer or PDA such that the input element 26 may be used as the embodiment shown in FIG. 4 by detaching and/or attaching the input element 26 with respect to the case 14 in response to user's demands.

Hereinabove, the present invention has been explained using practical embodiments illustrated in the drawings; however, the present invention may not be limited to the specific embodiments described above and it may be understood by a person skilled in the art that additions, omissions, or other embodiments about sizes, material, shapes or other detailed parts of the present input elements maybe possible in equivalent scope.

### BRIEF DESCRIPTION OF DRAWINGS

FIG. 1 An information processing apparatus which comprises a touch-pad and is able to be used in the present invention.

FIG. 2 An embodiment of an input element of the present invention.

FIG. 3 A method of the present invention for making inputs to an information processing apparatus.

FIG. 4 A construction of a pointing device for an information processing apparatus with a conventional touch-pad.

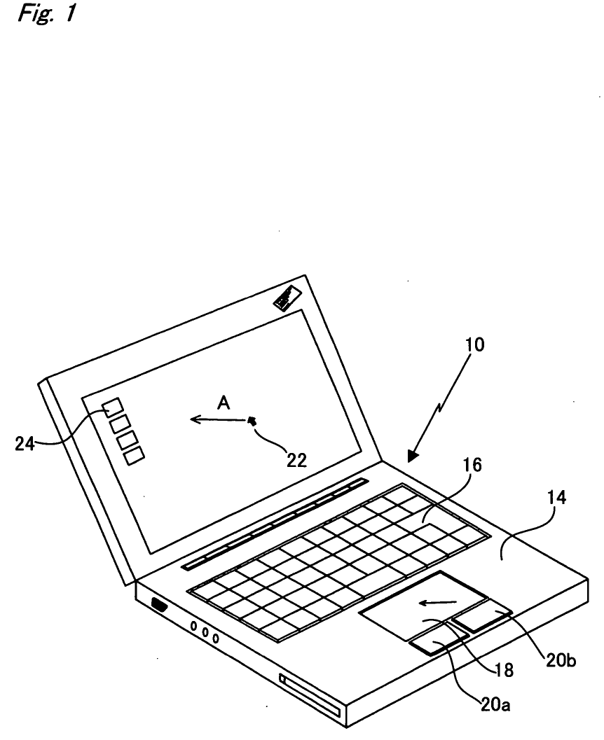

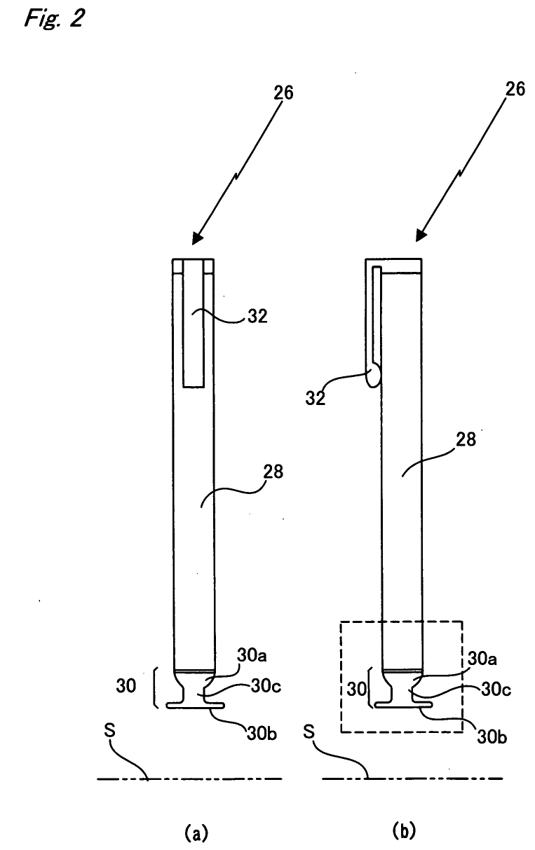

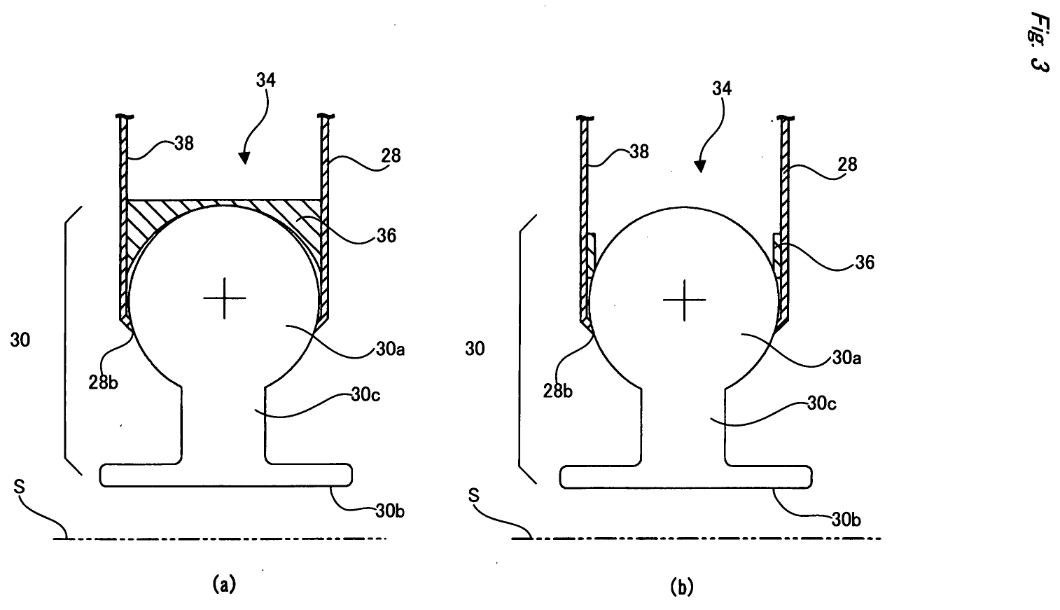

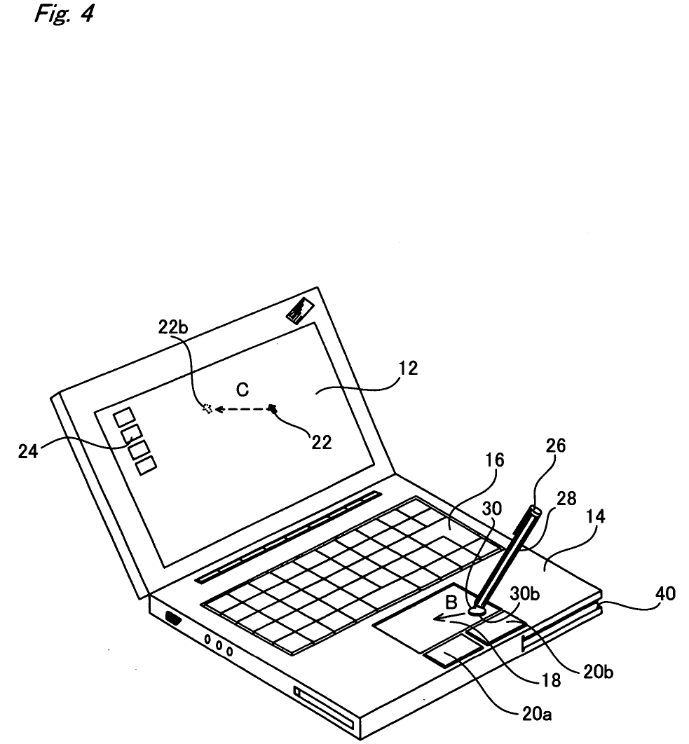

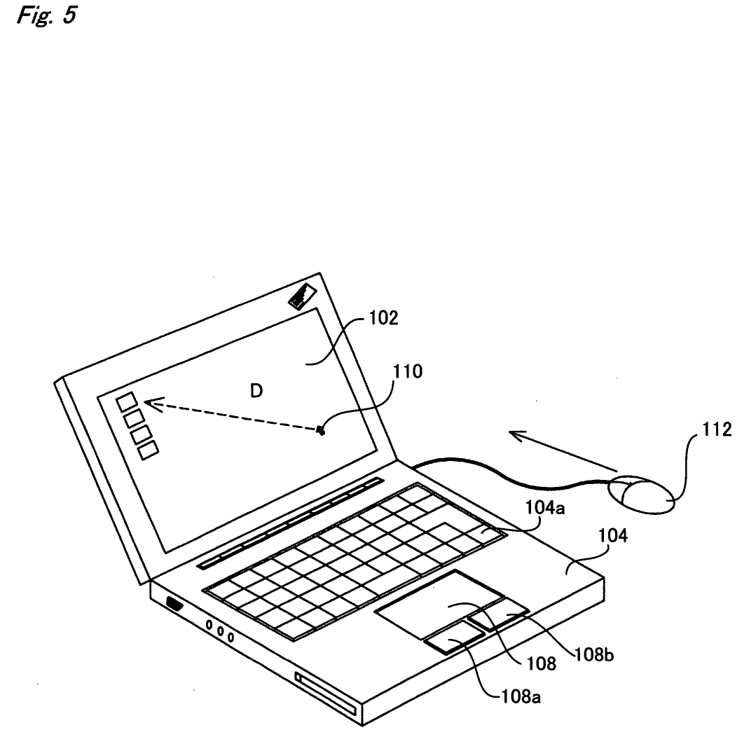

### DESCRIPTION OF NUMERALS

10—information processing apparatus

12—display part

14—case

16—keyboard

18—touch-pad

20a, 20b—button

22, 22b—pointer

24—icon

26—input element

28—grip part

30—pad contact part

30a—ball shaped part

30b—contact face

30c—connection part

32—clip part

34—inner space

36—engaging member

38—inner face

40—retainer space

1. An input element used for a touch-pad disposed to an information processing apparatus, said touch-pad being responsible to changes of a static capacity, said input element comprising a conductive pad contact part making a face-to-face contact onto said touch-pad.

2. The input element according to claim 1, said input element further comprising a conductive grip part, said grip part and said pad contact part being connected via a pivot connection therebetween.

3. The input element according to claim 1, said input element having a paper weight shape or a pencil shape, said input element making an input to said information processing apparatus through said change of said static capacity interfaced by said touch-pad.

4. A method for making an input to an information processing apparatus via a touch-pad, said touch pad of said information processing apparatus, said touch-pad being responsible to a change of a static capacity said method comprising the steps of:
providing an input element comprising a conductive pad contact part which makes a face-to face contact onto said touch-pad; and
making said input element contact to a touch-pad surface in a face-to-face manner such that said static capacity is changed.

5. The input element according to claim 2, said input element having a paperweight shape or a pencil shape, said input element configured to make an input to said information processing apparatus through said change of said static capacity interfaced by said touch-pad.
